(19) United States
(12) Patent Application Publication
(10) Pub. No.: US 2017/0362491 A1
(43) Pub. Date: Dec. 21, 2017

(54) SYSTEM AND RELATED METHOD TO SEAL FRACTURED SHALE

(71) Applicant: University of Virginia Patent Foundation, d/b/a University of VA Licensing & Ventures Group, Charlottesville, VA (US)

(72) Inventors: Andres F. CLARENS, Charlottesville, VA (US); Jeffrey P. FITTS, New York, NY (US); Zhiyuan TAO, Charlottesville, VA (US)

(21) Appl. No.: 15/534,747

(22) PCT Filed: Dec. 9, 2015
(86) PCT No.: PCT/US15/64687

§ 371 Date: Jun. 9, 2017

Related U.S. Application Data
(60) Provisional application No. 62/089,779, filed on Dec. 9, 2014.

(51) Int. Cl. C09K 8/504; C04B 28/02; C04B 28/00; E21B 33/138; C04B 28/08

(52) U.S. Cl. CPC C09K 8/5045; E21B 33/138; C04B 28/082; C04B 28/001; C04B 28/021; C04B 28/006; C09K 2208/10

(57) ABSTRACT

A method of pumping a fluid and reactive solid into a mineral formation includes the fluid reacting with the mineral formation to produce a nucleation product. The method may be used in shale formations to seal fissures and prevent leakage. The fluid used in this method may comprise CO₂ and the nucleation products may be the products of carbonation reactions. A cement formed by reacting CO₂ with a reactive solid under deep geological formation conditions is also disclosed.

### TECHNICAL FIELD

A method of pumping a fluid and a reactive solid into a mineral formation, wherein the fluid reacts with the mineral formation to produce a nucleation product, and a cement formed by the method.

### BACKGROUND

Shale oil and gas resources are being widely developed in the United States and elsewhere even though the environmental consequences are still poorly understood (Kargbo et al., Environmental Science & Technology 2010, 44, (15), 5679-5684). On a regional scale, seepage and leakage of fracturing fluids, contaminated native brines and natural gas into ground water resources is of great concern (Osborn et al., Proceedings of the National Academy of Sciences 2011, 108, (20), 8172-8176). These leaks could impact air and water quality both during the production stages of the well life cycle, and once the original operation is shut down during which time leaks may persist for decades (Burnham et al., Environmental Science & Technology 2011, 46, (2), 619-627). On a global scale, shale gas development is a concern because greenhouse gas emission resulting from its extraction and consumption will negatively impact the climate (Khosrokhavar et al. Environ. Process. 2014, 1-17). One estimate is that up to 100 Gigatonnes of carbon are stored in the recoverable hydrocarbons of shale formations, which is greater than seven times current annual global emissions (Pachauri et al., Contribution of Working Groups I, II and III to the Fourth Assessment Report of the Intergovernmental Panel on Climate Change. In IPCC, Ed. Geneva, Switzerland, 2007). Given both the near field and global risks, methods to manage the present and future implications of shale production must be developed (King et al., Thirty Years of Gas Shale Fracturing: What Have We Learned? In Society of Petroleum Engineers: 2010).

The boom in shale gas extraction has been enabled largely by two technologies, horizontal drilling and hydraulic fracturing (Kerr et al., Science 2010, 328, (5986), 1624-1626). Horizontal drilling provides access to a large areal extent of a shale formation's typically deep and thin hydrocarbon bearing zones from a single well pad. Pressurized aqueous fluids are then forced through perforations within these horizontal well segments to create dense fracture networks that cut across gas-conducting bedding planes. Proppants, most often sand, are used to keep the fractures open during fracture fluid flowback and hydrocarbon production stages (Weaver et al., Sustaining Fracture Conductivity. In Society of Petroleum Engineers: 2005). Following production, these flow paths could enable fluid migration and contaminant transport into overlying sedimentary formations where faults and abandoned wells could then conduct these fluids into near-surface formations, posing a long-term risk to groundwater resources (Darrah et al., Proceedings of the National Academy of Sciences 2014, 201322107.).

The following publications are incorporated by reference in their entirety into this document. IPCC Contribution of Working Groups I, II and III to the Fourth Assessment Report of the Intergovernmental Panel on Climate Change; Geneva, Switzerland, 2007; p 104. Bernard, S.; Horsfield, B.; Schulz, H.-M.; Schreiber, A.; Wirth, R.; Anh Vu, T. T.; Perssen, F.; Könitzer, S.; Volk, H.; Sherwood, N.; Fuentes, D., Multi-scale detection of organic and inorganic signatures provides insights into gas shale properties and evolution. Chemie der Erde—Geochemistry 2010, 70, Supplement 3, (0), 119-133. Kvenvolden, K. A., Methane hydrate—A major reservoir of carbon in the shallow geosphere? Chemical Geology 1988, 71, (1-3), 41-51. Probstein, R. F.; Hicks, R. E., Synthetic fuels. 1990; p Medium: X; Size: Pages: (504 p). Gregory, K. B.; Vidic, R. D.; Dzombak, D. A., Water Management Challenges in Development of Shale Gas with Hydraulic Fracturing. Elements 2011, 7, (3), 181-186. Caldeira, K.; Davis, S. J., Accounting for carbon dioxide emissions: A matter of time. Proceedings of the National Academy of Sciences 2011, 108, (21), 8533-8534. Bachu, S.; Gunter, W. D.; Perkins, E. H., Aquifer disposal of CO2: Hydrodynamic and mineral trapping. Energy Conversion and Management 1994, 35, (4), 269-279. Bruant, R. G. J.; Celia, M. A.; Guswa, A. J.; Peters, C. A., Safe Storage of CO2 in Deep Saline Aquifiers. Environmental Science & Technology 2002, 36, (11), 240A-245A. DOE, Carbon Sequestration Atlas of the United States and Canada—Third Edition (Atlas III). NETL: Pittsburgh, Pa., 2010. NAS Induced Seismicity Potential in Energy Technologies; National Academies of Science, 2012. Eccles, J. K.; Pratson, L.; Newell, R. G.; Jackson, R. B., Physical and economic potential of geological CO2 storage in saline aquifers. Environmental Science & Technology 2009, 43, (6), 1962-1969. NAE Grand challenges for engineering; National Academy of Engineering: Washington, DC, 2011. Enkvist, P.-A.; Naucler, T.; Rosander, J. A cost curve for greenhouse gas reduction; The McKinsey Quarterly, 2007. EIA Natural Gas Year-in-Review; U.S. Energy Information Administration: Washington, DC, 2012. DOE/NETL Carbon Sequestration Program: Technology Program Plan; National Energy Technology Laboratory: 2011. Bachu, S.; Adams, J. J., Sequestration of CO2 in geological media in response to climate change: capacity of deep saline aquifers to sequester CO2 in solution. Energy Conversion and Management 2003, 44, (20), 3151-3175. Benson, S. M.; Cole, D. R., CO2 Sequestration in Deep Sedimentary Formations. Elements 2008, 4, (5), 325-331. Oldenburg, C. M., Migration mechanisms and potential impacts of CO2 leakage and seepage. In Carbon Capture and Storage, Wilson; Gerard, Eds. Blackwell: 2007. Pruess, K., The TOUGH Codes—A Family of Simulation Tools for Multiphase Flow and Transport Processes in Permeable Media. Vadose Zone Journal 2004, 3, (3), 738-746. Giammar, D. E.; Bruant Jr, R. G.; Peters, C. A., Forsterite dissolution and magnesite precipitation at conditions relevant for deep saline aquifer storage and sequestration of carbon dioxide. Chemical Geology 2005, 217, (3-4), 257-276. Zhang, C.; Dehoff, K.; Hess, N.; Oostrom, M.; Wietsma, T. W.; Valocchi, A. J.; Fouke, B. W.; Werth, C. J., Pore-scale study of transverse mixing induced CaCO3 precipitation and permeability reduction in a model subsurface sedimentary system. Environmental Science & Technology 2010, 44, (20), 7833-7838. 22. Hu, Y.; Ray, J. R.; Jun, Y.-S., Biotite-brine interactions under acidic hydrothermal conditions: Fibrous illite, goethite, and kaolinite formation and biotite surface cracking. Environmental Science and Technology 2011, 45, (14), 6175-6180. Shao, H.; Ray, J. R.; Jun, Y.-S., Dissolution and precipitation of clay minerals under geologic CO2 sequestration conditions: CO2 brinephlogopite interactions. Environmental Science and Technology 2010, 44, (15), 5999-6005. Shao, H.; Ray, J. R.; Jun, Y.-S., Effects of organic ligands on supercritical CO2-induced phlogopite dissolution and secondary mineral formation. Chemical Geology 2011, 290, (3-4), 121-132. Juanes, R.; Spiteri, E. J.; Orr, F. M., Jr.; Blunt, M. J., Impact of relative permeability hysteresis on geological CO2 storage. Water Resour. Res. 2006, 42, (12), W12418. Griffith, C.; Dzombak, D.; Lowry, G., Physical and chemical characteristics of potential seal strata in regions considered for demonstrating geological saline CO2 sequestration. Environmental Earth Sciences 2011, 64, (4), 925-948. Xu, T.; Apps, J. A.; Pruess, K., Mineral sequestration of carbon dioxide in a sandstone-shale system. Chemical Geology 2005, 217, (3-4), 295-318. Dammel, J. A.; Bielicki, J. M.; Pollak, M. F.; Wilson, E. J., A Tale of Two Technologies: Hydraulic Fracturing and Geologic Carbon Sequestration. Environmental Science & Technology 2011, 45, (12), 5075-5076. Martineau, D. F., History of the Newark East field and the Barnett Shale as a gas reservoir. AAPG Bulletin 2007, 91, (4), 399-403. Sakhaee-Pour, A.; Bryant, S. L., Gas Permeability of Shale. In SPE Annual Technical Conference and Exhibition, Society of Petroleum Engineers Denver, Colo., 2007. Nuttall, B. C.; Eble, C. F.; Drahovzal, J. A.; Bustin, R. M. Analysis of Devonian black shales in kentucky for potential carbon dioxide sequestration and enhanced natural gas production; Kentucky Geological Survey: Lexington, Ky., 2005. Busch, A.; Alles, S.; Gensterblum, Y.; Prinz, D.; Dewhurst, D.; Raven, M.; Stanjek, H.; Krooss, B., Carbon dioxide storage potential of shales. International Journal of Greenhouse Gas Control 2008, 2, (3), 297-308. Kang, S. M.; Fathi, E.; Ambrose, R. J.; Akkutlu, I. Y.; Sigal, R. F., Carbon Dioxide Storage Capacity of Organic-Rich Shales. SPE Journal 2011, 16, (4), 842-855. Aminto, A.; Olson, M. S., Four-compartment partition model of hazardous components in hydraulic fracturing fluid additives. Journal of Natural Gas Science and Engineering 2012, 7, (0), 16-21. Gaurav, A.; Dao, E. K.; Mohanty, K. K., Evaluation of ultra-light-weight proppants for shale fracturing. Journal of Petroleum Science and Engineering 2012, 92-93, (0), 82-88. Gupta, D. V. S. In Unconventional fracturing fluids for tight gas reservoirs, SPE Hydraulic Fracturing Technology Conference, The Woodlands, Tex., 2009; SPE: The Woodlands, Tex., 2009. Horton, S., Disposal of Hydrofracking Waste Fluid by Injection into Subsurface Aquifers Triggers Earthquake Swarm in Central Arkansas with Potential for Damaging Earthquake. Seismological Research Letters 2012, 83, (2), 250-260. Gomberg, J.; Davis, S., Stress-strain changes and triggered seismicity at The Geysers, Calif. J. Geophys. Res. 1996, 101, (B1), 733-749. Zoback, M. D.; Gorelick, S. M., Earthquake triggering and large-scale geologic storage of carbon dioxide. Proceedings of the National Academy of Sciences 2012, 109, (26), 10164-10168. Horwarth, R. W.; Santoro, R.; Ingraffea, A., Methane and the greenhouse-gas footprint of natural gas from shale formations. Climatic Change 2011. Weber, C. L.; Clavin, C., Life Cycle Carbon Footprint of Shale Gas: Review of Evidence and Implications. Environmental Science & Technology 2012, 46, (11), 5688-5695. Khoo, H. H.; Tan, R. B. H., Life cycle investigation of CO2 recovery and sequestration. Environmental Science and Technology 2006, 40, (12), 4016-4024. Stauffer, P. H.; Viswanathan, H. S.; Pawar, R. J.; Guthrie, G. D., A System Model for Geologic Sequestration of Carbon Dioxide. Environmental Science & Technology 2008, 43, (3), 565-570. Jaramillo, P.; Griffin, W. M.; McCoy, S. T., Life Cycle Inventory of CO2 in an Enhanced Oil Recovery System. Environmental Science & Technology 2009, 43, (21), 8027-8032. Melaina, M.; Webster, K., Role of Fuel Carbon Intensity in Achieving 2050 Greenhouse Gas Reduction Goals within the Light-Duty Vehicle Sector. Environmental Science & Technology 2011, 45, (9), 3865-3871. Karvetski, C. W.; Lambert, J. H.; Keisler, J. M.; Linkov, I., Integration of Decision Analysis and Scenario Planning for Coastal Engineering and Climate Change. Systems, Man and Cybernetics, Part A: Systems and Humans, IEEE Transactions on 2011, 41, (1), 63-73. Martinez, L. J.; Lambert, J. H.; Karvetski, C. W., Scenario-informed multiple criteria analysis for prioritizing investments in electricity capacity expansion. Reliability Engineering &amp; System Safety 2011, 96, (8), 883-891. Clarens, A. F., K. F. Hayes, S. J. Skerlos, Feasibility of Metalworking Fluids Delivered in Supercritical Carbon Dioxide. Journal of Manufacturing Processes 2006. Clarens, A. F.; Zimmerman, J. B.; Keoleian, G. A.; Hayes, K. F.; Skerlos, S. J., Comparison of Life Cycle Emissions and Energy Consumption for Environmentally Adapted Metalworking Fluid Systems. Environmental Science and Technology 2008, (Accepted) Earliest Publication Fall 2008. Wang, S.; Edwards, I.; Clarens, A., Wettability phenomena at the CO2-brine-mineral interface: Implications for geologic carbon sequestration. Environmental Science & Technology 2012, In Review. Wang, S.; Clarens, A. F., The effects of CO2-brine rheology on leakage processes in geologic carbon sequestration. Water Resources Research 2012, In Press. Rhee, J. S.; Iamchaturapatr, J., Carbon capture and sequestration by a treatment wetland. Ecological Engineering 2009, 35, (3), 393-401. Clarens, A. F.; Nassau, H.; Resurreccion, E. P.; White, M. A.; Colosi, L. M., Environmental Impacts of Algae-Derived Biodiesel and Bioelectricity for Transportation. Environmental Science & Technology 2011, In Press. Clarens, A. F.; Resurreccion, E. P.; White, M. A.; Colosi, L. M., Environmental Life Cycle Comparison of Algae to Other Bioenergy Feedstocks. Environmental Science & Technology 2010, 44, (5), 1813-1819. Liu, X.; Clarens, A. F.; Colosi, L. M., Algae biodiesel has potential despite inconclusive results to date. Bioresource Technology 2012, 104, (0), 803-806. Clifford, T., Fundamentals of Supercritical Fluids. Oxford University Press: New York: 1999. Clarens, A.; Younin, A.; Wang, S.; Allaire, P. E., Feasibility of Gas-Expanded Lubricants I Tilting Pad Journal Bearings. Journal of Tribology—ASME 2010, July. Lambert, J. H.; Wu, Y. J.; You, H.; Clarens, A. F.; Smith, B., Climate Change Influence to Priority Setting for Transportation Infrastructure Assets. ASCE—Journal of Infrastructure Systems 2012, In Press. Gosse, C. A.; Smith, B. L.; Clarens, A. F., Environmentally preferable pavement management systems. ASCE—Journal of Infrastructure Systems 2012, in Press. Braun, B.; Charney, R.; Clarens, A.; Farrugia, J.; Kitchens, C.; Lisowski, C.; Naistat, D.; O'Neil, A., Completing our education. Green chemistry in the curriculum. Journal of Chemical Education 2006, 83, (8), 1126-1128. Star, S. L.; Griesemer, J. R., Institutional Ecology, ‘Translations’ and Boundary Objects: Amateurs and Professionals in Berkeley's Museum of Vertebrate Zoology, 1907-39. Social Studies of Science 1989, 19, (3), 387-420. Lee, C., Boundary Negotiating Artifacts: Unbinding the Routine of Boundary Objects and Embracing Chaos in Collaborative Work. Computer Supported Cooperative Work (CSCW) 2007, 16, (3), 307-339. Carlile, P. R., A Pragmatic View of Knowledge and Boundaries: Boundary Objects in New Product Development. Organization Science 2002, 13, (4), 442-455. Madni, A. M.; Moini, A., Viewing Enterprises As Systems-Of-Systems (SOS): Implications For SOS Research. Journal of Integrated Design and Process Science 2007, 11, (2), 3-13. Harry, D.; Donath, J., Information spaces—building meeting rooms in virtual environments. In CHI '08 extended abstracts on Human factors in computing systems, ACM: Florence, Italy, 2008; pp 3741-3746. Deslauriers, L.; Schelew, E.; Wieman, C., Improved Learning in a Large-Enrollment Physics Class. Science 2011, 332, (6031), 862-864. Chrobot-Mason, D.; Thomas, K. M., Minority Employees in Majority Organizations: The Intersection of Individual and Organizational Racial Identity in the Workplace. Human Resource Development Review 2002, 1, (3), 323-344. Mazza, R. L., Liquid-Free CO2/Sand Stimulations: An Overlooked Technology—Production Update. In 2001. McClain, J. B.; Betts, D. E.; Canelas, D. A.; Samulski, E. T.; DeSimone, J. M.; Londono, J. D.; Cochran, H. D.; Wignall, G. D.; Chillura-Martino, D.; Triolo, R., Design of nonionic surfactants for supercritical carbon dioxide. Science 1996, 274, (5295), 2049. Sarbu, T.; Styranec, T. J.; Beckman, E. J., Design and synthesis of low cost, sustainable CO2 philes. Industrial and Engineering Chemistry Research 2000, 39, (12), 4678-4683. DeSimone, J. M., Practical approaches to green solvents. Science 2002, 297, (5582), 799-803. Span, R.; Wagner, W., A new equation of state for carbon dioxide covering the fluid region from the triple-point temperature to 1100 K at pressures up to 800 MPa. Journal of Physical and Chemical Reference Data 1996, 25, (6), 1509-96. Ellis, B. R.; Peters, C. A.; Fitts, J. P.; Bromhal, G. S.; McIntyre, D. L.; Warzinski, R. P.; Rosenbaum., E. J., Deterioration of a fractured carbonate caprock exposed to CO2-acidified brine flow. Greenhouse Gases: Science and Technology 2011, 1, (3), 248. Sharma, G.; Mohanty, K. K., Wettability Alteration in High Temperature and High Salinity Carbonate Reservoirs. In SPE Annual Technical Conference and Exhibition, Society of Petroleum Engineers: Denver, Colo., USA, 2011.

The following published United States patent applications are incorporated by reference in their entirety into this application. US 2010/0196104 A1. US 2011/0033239 A1. US 2011/0030957 A1. US 2012/0027516 A1.

The following United States patents are incorporated by reference in their entirety into this application. U.S. Pat. No. 7,128,153 B2. U.S. Pat. No. 7,032,660 B2. U.S. Pat. No. 7,077,198 B2. U.S. Pat. No. 7,063,145 B2.

### BRIEF DESCRIPTION OF DRAWINGS

FIG. 1 shows an exemplary application of a method of the invention, wherein this method is used in a shale gas extraction operation.

FIG. 2 is a micrograph showing shale particles before and after carbonization according to a method of the invention.

### DETAILED DESCRIPTION

A method of pumping a fluid and a reactive solid into a mineral formation, wherein the fluid reacts with the mineral formation to produce a solid reaction product is disclosed. In one embodiment the fluid comprises CO₂. In another embodiment the fluid comprises water and CO₂. In one embodiment the solid reaction product is the result of a carbonation reaction. In another embodiment the solid reaction product is a calcite, amorphous silica, or other nucleation or precipitation product. In one embodiment the CO₂ is supercritical CO₂. In another embodiment the CO₂ is from a waste stream. In one embodiment the water is a solution of carbonates. In another embodiment the carbonates have a concentration of greater than or equal to 0.1 M, or greater than or equal to 1.0 M, or greater than or equal to 10.0 M. In one embodiment the carbonates are carbonic acid, in another embodiment the carbonates are bicarbonates. In some embodiments the water is an alkaline solution. In some embodiments the alkaline solution has a pH of 7 or greater, or 8 or greater, or 9 or greater, or 10 or greater, or 11 or greater, or 12 or greater.

In one embodiment, the reactive solid comprises a mineral. In another embodiment the mineral is comprised of one or more of quartz, calcite, amorphous silica, dolomite, kaolinite, illite, mica, and others. In another embodiment the mica comprises one or more of phlogopite, muscovite, biotite, and others. In another embodiment the reactive solid comprises a divalent silicate. In another embodiment the reactive solid comprises one or more of magnesium and calcium silicate. In another embodiment the reactive solid comprises a material selected from one or more of brucite (Mg(OH)₂), chrysotile (Mg₃Si₂O₅(OH)₄), forsertite (Mg₂SiO₄), harzburgite (CaMgSi₂O₆+(Fe,Al)), olivine ((Mg,Fe)₂SiO₄), orthopyroxene CaMgSi₂O₆+(Fe,Al)), serpentine (Mg₃Si₂O₅(OH)₄), wollastonite (CaSiO₃), and others. In another embodiment the material consists of wollastonite (CaSiO₃).

In one embodiment the reactive solid comprises an alkaline waste product material. In another embodiment the alkaline waste product comprises a material selected from one or more of blast furnace slag from steel manufacturing, bottom ash, fly ash, kiln dust, mine tailings, municipal solid waste ash, paper mill waste, steelmaking slag, and others.

In one embodiment of the method the reaction occurs at conditions typical of a deep geological formation, for example a formation located 1000 meters below ground or deeper, or 1500 meters below ground or deeper, or 2000 meters below ground or deeper, or 2500 meters below ground or deeper, or 3000 meters below ground or deeper. For example, the reaction may occur at different pressures. In another embodiment the reaction occurs at 15-25 MPa. In another embodiment the reaction occurs at 18-22 MPa. The reaction may also occur within a range of different temperatures. In another embodiment the reaction occurs at 40-175° C. In another embodiment the reaction occurs at 70-100° C. In some embodiments the reaction may be pressurized by a pump.

In one embodiment of the method the reaction occurs via a dissolution reaction in which a solid donates a divalent cation, followed by a precipitation reaction in which a solid phase material nucleates within the mineral formation.

In one embodiment of the method the mineral formation is a fractured shale formation. In another embodiment the mineral formation is wellbore material. In another embodiment the mineral formation is a porous mineral formation, in another embodiment the mineral formation is a fractured mineral formation. In another embodiment an analysis is performed to determine optimum chemistry for a particular application.

In one embodiment of the method the carbonate material partially or completely seals a fissure in the mineral formation. In another embodiment the carbonate material partially or completely closes a fractured shale formation. In another embodiment the carbonate material cements the shale formation.

In one embodiment the fluid further comprises a proppant. In another embodiment the reactive solid comprises a proppant. In one embodiment the fluid further comprises a lubricant. In another embodiment the fluid further comprises a surfactant. In another embodiment the fluid is further comprised of polyolefin.

In one embodiment the method is used to sequester carbon. In another embodiment the method is used to stabilize fractured shale to reduce seismicity. In another embodiment the method is used to decrease fluid connectivity to minimize leakage. In another embodiment the decrease in fluid connectivity reduces the porosity and permeability of the mineral formation. In another embodiment the reactive solid is used as a proppant, allowing the formation to settle back to its pre-fracture geometry.

In one embodiment of the method the reactive solid is first added, and the fluid is added later. In another embodiment the reactive solid is added along with a cement mixture.

In one embodiment the reactive solid comprises nanoparticles. In another embodiment the nanoparticles are designed to target leaking fractures in a mineral formation.

In one embodiment the method is used for enhanced oil recovery. In another embodiment the method is used to recover methane from methane hydrate formations.

Another aspect of this disclosure relates to a cement formed by reacting carbon dioxide with a reactive solid under deep geological formation conditions. In one embodiment the cement is a carbonate, a silicate, or a mixture of carbonates and silicates. In one embodiment the deep geological formation conditions comprise a pressure of 15-25 MPa. In another embodiment the deep geological formation conditions comprise a pressure of 18-22 MPa. In another embodiment the deep geological formation conditions comprise a temperature of 40-175° C. In another embodiment the deep geological formation conditions comprise a pressure of 70-100° C.

In one embodiment the cement reduces the porosity and permeability of a mineral formation.

### DETAILED DESCRIPTION OF THE FIGURES

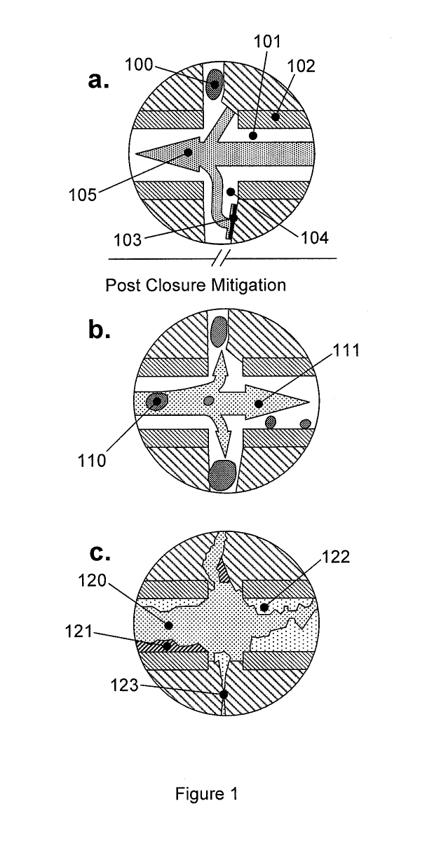

FIG. 1 shows one potential embodiment of the method. In this embodiment, the method is used to seal a shale formation. In FIG. 1a, a conventional shale fracturing well operation is shown. A borehole 101 in the shale, containing a casing 102 is used to extract natural gas 105. Off of the borehole 101 may exist fractures 104 and organic materials such as kerogen 103 contained therein. Proppants 100 are used to maintain well integrity and aid in extraction of natural gas.

FIG. 1b shows one potential embodiment of the method of this disclosure. FIG. 1b shows a fluid 111 being pumped into the borehole along with a reactive solid 110. The fluid and reactive solid flow into the fissures and begin to react with the surrounding shale to form carbonates. FIG. 1c shows the end result of the method in this embodiment, wherein a solid carbonate has formed 122 along with other possible solid byproducts such as silica 121. These solid byproducts close the fissure 123, sealing the well and trapping the CO₂ 120.

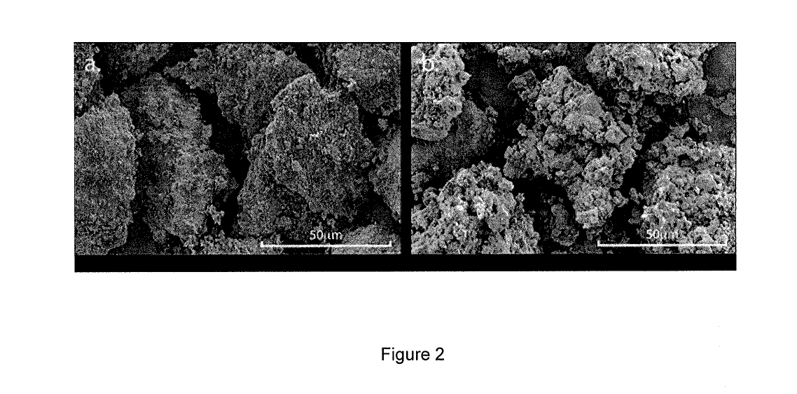

FIG. 2 shows an electron micrograph of shale particles used in Example 1 below. FIG. 2 shows the shale particles before FIG. 2a and after FIG. 2b reaction with the fluid. Precipitated solid material is visible in FIG. 2b as a bulky surface coating on the shale particles.

### Example 1

Shale samples were obtained from Ward's Scientific (Oil Shale #47E7477). CaSiO₃ (99%) and CaCO₃ (99%) were obtained from Sigma-Aldrich. Food-grade liquid CO₂ was supplied by Robert's Oxygen. All reagents were used as received. Solid shale samples were ground using miller jars and sieved to obtain particles with diameters in the range of 39-177 μm. Reactants were packed in a stainless steel reactor (MS-13, HIP) at a 1:5 (CaSiO₃:shale) mass ratio with DI water and pressurized with CO₂ to the desired reaction pressure using a syringe pump (500 HP—Teledyne Isco). Temperature control was achieved using an oven (Despatch Inc.) with a shaker to ensure adequate mixing during the experiment. The changes in the composition of the samples were quantified using a PANalytical X'Pert Pro Multipurpose Diffractor (XRD) unit with monochromatic Cu-Kα radiation. TiO₂ was chosen as the internal reference for its distinguishable peaks relative to shale and CaCO₃. The morphological and elemental composition changes of mineral samples were characterized using a Quanta 650 Scanning Electron Microscope (SEM) coupled with energy dispersive X-ray (EDS) spectroscopy.

Quantitative XRD analyses were carried out to determine the extent of reaction and conversion of wollastonite to calcite at pressure and temperature combinations characteristic of shale formations. An internal TiO2 standard was used to calibrate the intensity of calcite peaks. The results summarized in Table 1 indicate that the reaction achieved greater than 50% conversion (measured in terms of CaCO3 generation) after 24 hours.

TABLE 1

| Mineral | CO₂ Pressure | Temperature | Conversation |
|---|---|---|---|
| Composition | (MPa) | (° C.) | Extent |
| 50% Shale + 50% | 21.4 | 75 | 55 ± 2% |
| CaSiO₃ | | | |
| 50% Shale + 50% | 21.4 | 95 | 58 ± 1% |
| CaSiO₃ | | | |
| 50% Shale + 50% | 15.2 | 75 | 50 ± 1% |
| CaSiO₃ | | | |

### Example 2

Adhesion was studied under both equilibrium and dynamic conditions under reservoir pressure and temperature conditions (50° C. and 20 MPa) and a range of pH and ionic strength in fresh and carbonated synthetic brines on pendant droplets using methods previously reported (Wang et al., Environ. Sci. Technol. 2013, 47 (1), 234-241). Seven representative minerals including quartz, calcite, amorphous silica, dolomite, kaolinite, illite, and phlogopite mica were selected since these constitute most of the minerals on the pore surfaces in sandstones (Peters, Chem. Geol. 2009, 265 (1-2), 198-208). These minerals all have hydroxyl functional groups, for example, aluminol, silanol, silanediols and bridged hydroxyls, at the solid surface and are sensitive to the adjacent aqueous phase pH and ionic strength conditions. Phlogopite mica was selected as a model mica species recognizing that many of the surface characteristics of interest in adhesion (e.g., surface functional groups, surface roughness) are shared by other mica species (i.e., muscovite and biotite).

Mineral samples were prepared by sectioning high purity rocks (Ward's Natural Science), lapping the experimental surface according to the crystal structure with a diamond grinding wheel, and then polishing them with a series of silicon carbide sanding papers down to a roughness of 1-5 μm. Some of the surfaces did not need polishing. Phlogopite cleaved easily into basal plane sheets to create surfaces that are smooth on the scale of 10 s of nanometers. The high-purity amorphous silica was not polished and used as received since it was polished at the factory (Heraeus Quarzglas). Some of the phlogopite and silica surfaces were made rougher using the sand papers in order to study the effect of roughness on adhesion. Roughness was measured using a profilometer (Dektak 8, Veeco) for the rough surfaces and an AFM (Asylum Research cypher scanning probe microscope) for smooth surfaces. Before experiments, all equipment and samples were carefully cleaned following the protocol previously described (Wang et al., Water Resour. Res. 2012, 48, (8), W08518; Wang et al., Environ. Sci. Technol. 2013, 47 (1), 234-241). Extensive care was taken to exclude any source of contamination, especially organic matter which could strongly affect wettability. All samples were flushed with at least 200 mL (˜10 times pressure vessel volume) brine solution over 1 h to equilibrate the surfaces of the minerals with the aqueous phase. All experiments were repeated at least three times.

To evaluate adhesion of CO₂ droplets on the mineral surface, a modified form of the advancing/receding contact angle measurement was carried out. To more closely approximate the mechanics of the ‘stick-peel-crack’ tests used to measure axial tensile force in solid mechanics, which is proportional to the adhesive energy and work of adhesion (Kendall, Science. 1994, 263, 1720-1725), we positioned the injection needle 1.5-3 mm below the surface and then outfitted the injection tubing with two pin valves. These two pin valves in sequence allowed for the precise control of captive CO₂ droplet flows into and out of the pressure cell by regulating the relative pressure of the pure CO₂ in the space between the valves and the pressure in the vessel. N₂ control experiments were conducted under identical conditions on phlogopite and silica surfaces. Adhesion was determined based on the tendency of a CO₂ droplet to stick to the mineral surface under tensile force created by the pressure difference between the injection needle and the pressure vessel. Irregular contact lines and increased wettability were also common qualitative characteristics of adhered droplets. Table 1 explores the relationship between adhesion, ionic strength, and pressure. Table 2 explores the relationship between adhesion, mineral composition, roughness, and pressure. Experiments for Table 3 were performed at an ionic strength of 1.5 M NaCl. The error range in Tables 2 and 3 represent one standard deviation, and it should be noted that negative percentage is not realistic.

TABLE 2

| P_{CO2} (MPa) | |
|---|---|
| 0 | 20 |

| | |
|---|---|
| Ionic Strength (M) | Droplets Adhered (%) |

Phlogopite and CO₂

| | | |
|---|---|---|
| 0.00 | 26 ± 13 | 19 ± 11 |
| 0.10 | 49 ± 14 | 82 ± 17 |
| 0.46 | 58 ± 25 | 76 ± 13 |
| 0.86 | 52 ± 17 | 71 ± 23 |
| 1.21 | 55 ± 22 | 79 ± 7 |

Silica and CO₂

| | | |
|---|---|---|
| 0.00 | 9 ± 16 | 26 ± 44 |
| 1.21 | 38 ± 49 | 31 ± 54 |

Phlogopite and N₂

| | | |
|---|---|---|
| 0.00 | 24 ± 15 | 30 ± 22 |
| 1.21 | 35 ± 20 | 23 ± 21 |

Silica and N₂

| | | |
|---|---|---|
| 0.00 | 74 ± 46 | 66 ± 53 |
| 1.21 | 66 ± 54 | 67 ± 55 |

TABLE 3

| | Roughness | Droplets Adhered (%) | |
|---|---|---|---|
| Mineral | (nm) | 0 MPa CO₂ | 20 MPa CO₂ |
| phlogopite | 6.4 ± 1.0 | 55 ± 12 | 79 ± 7 |
| | 1600 ± 472 | 4 ± 6 | 11 ± 13 |
| calcite | 1.9 ± 1.4 | 8 ± 4 | 6 ± 6 |
| | 4725 ± 1195 | 2 ± 1 | 1 ± 1 |
| amorphous | 5.8 ± 1.8 | 38 ± 49 | 31 ± 54 |
| silica | 2300 ± 360 | 1 ± 1 | 1 ± 0 |

1. A method comprising pumping a fluid and reactive solid into a mineral formation, wherein said fluid reacts with said solid to produce a solid reaction product.

2. The method of claim 1, wherein the solid reaction product is one or more of a carbonate and a silicate.

3. The method of claim 1, wherein the solid reaction product is a product of a carbonation reaction.

4. The method of claim 1, wherein the fluid comprises CO₂.

5. The method of claim 1, wherein the fluid comprises water and CO₂.

6. The method of claim 1, wherein the reactive solid comprises a mineral.

7. The method of claim 6, wherein the mineral is comprised of one or more of quartz, calcite, amorphous silica, dolomite, kaolinite, illite, and mica.

8. The method of claim 7, wherein the mica comprises one or more of phlogopite, muscovite, and biotite.

9. The method of claim 1, wherein the reactive solid comprises a divalent silicate.

10. The method of claim 9, wherein the reactive solid comprises one or more of magnesium and calcium silicate.

11. The method of claim 1, wherein the reactive solid comprises a material selected from one or more of brucite (Mg(OH)2), chrysotile (Mg₃Si₂O₅(OH)₄), forsertite (Mg₂SiO₄), harzburgite (CaMgSi₂O₆+(Fe,Al)), olivine ((Mg,Fe)₂SiO₄), orthopyroxene CaMgSi₂O₆+(Fe,Al)), serpentine (Mg₃Si₂O₅(OH)₄), and wollastonite (CaSiO₃).

12. The method of claim 11, wherein the reactive solid comprises wollastonite (CaSiO₃).

13. The method of claim 1, wherein the reactive solid comprises an alkaline waste product material.

14. The method of claim 13, wherein the alkaline waste product comprises a material selected from one or more of blast furnace slag from steel manufacturing, bottom ash, fly ash, kiln dust, mine tailings, municipal solid waste ash, paper mill waste, and steelmaking slag.

15. The method of claim 1, wherein the reaction occurs at conditions typical to a deep geological formation.

16. The method of claim 1, wherein the reaction occurs at 15-25 MPa.

17. The method of claim 16, wherein the reaction occurs at 18-22 MPa.

18. The method of claim 1, wherein the reaction occurs at 40-175° C.

19. The method of claim 18, wherein the reaction occurs at 70-100° C.

20. The method of claim 1, wherein said reaction occurs via a dissolution reaction in which a solid donates a divalent cation, followed by a precipitation reaction in which a solid phase material nucleates within the mineral formation.

21. The method of claim 1, wherein said mineral formation is a fractured shale formation.

22. The method of claim 1, wherein said mineral formation is comprised of one of is a wellbore material, a porous mineral formation; and a fractured mineral formation

23. The method of claim 21, wherein said carbonate material partially or completely closes fractured shale formation.

24. The method of claim 21, wherein said reaction product cements the mineral formation.

25. The method of claim 1, wherein said solid reaction product partially or completely seals a fissure in the mineral formation.

26. The method of claim 21, wherein the fluid further comprises a proppant.

27. The method of claim 21, wherein the reactive solid comprises a proppant.

28. The method of claim 1, wherein the method is used to sequester carbon.

29. The method of claim 21, wherein the method is used to stabilize fractured shale to reduce seismicity.

30. The method of claim 21, wherein the method is used to decrease fluid connectivity to minimize leakage.

31. The method of claim 1, wherein the reactive solid is first added, and the fluid is added later.

32. The method of claim 1, wherein the reactive solid is added along with a cement mixture.

33. The method of claim 1, wherein the reactive solid comprises nanoparticles.

34. The method of claim 33, wherein the nanoparticles are designed to target leaking fractures in shale.

35. The method of claim 1, wherein the fluid further comprises a surfactant.

36. The method of claim 1, wherein the fluid further comprises a lubricant.

37. The method of claim 1, wherein the fluid further comprises polyolefin.

38. The method of claim 1, wherein the method is used for enhanced oil recovery.

39. The method of claim 1, wherein the method is used to recover methane from methane hydrate formations.

40. A cement formed by reacting carbon dioxide with a reactive solid under deep geological formation conditions.

41. The cement of claim 40, wherein the cement comprises a carbonate, a silicate, or a mixture of carbonates and silicates.

42. The cement of claim 40, wherein the deep geological formation conditions comprise a pressure of 15-25 MPa.

43. The cement of claim 42, wherein the deep geological formation conditions comprise a pressure of 18-22 MPa.

44. The cement of claim 40, wherein the deep geological formation conditions comprise a temperature of 40-175° C.

45. The cement of claim 44, wherein the deep geological formation conditions comprise a pressure of 70-100° C.

46. The cement of claim 40, wherein the reactive solid comprises a mineral.

47. The cement of claim 40, wherein the mineral is comprised of one or more of quartz, calcite, amorphous silica, dolomite, kaolinite, illite, and mica.

48. The cement of claim 47 wherein the mica comprises one or more of phlogopite, muscovite, and biotite.

49. The cement of claim 40, wherein the reactive solid is an alkaline waste product material.

50. The cement of claim 49, wherein the alkaline waste product comprises a material selected from one or more of blast furnace slag from steel manufacturing, bottom ash, fly ash, kiln dust, mine tailings, municipal solid waste ash, paper mill waste, and steelmaking slag.

51. The cement of claim 40, wherein the reactive solid comprises a divalent silicate.

52. The cement of claim 51, wherein the reactive solid comprises a magnesium or calcium silicate.

53. The cement of claim 40, wherein the reactive solid comprises a material selected from one or more of brucite (Mg(OH)₂), chrysotile (Mg₃Si₂O₅(OH)₄), forsertite (Mg₂SiO₄), harzburgite (CaMgSi₂O₆+(Fe,Al)), olivine ((Mg, Fe)₂SiO₄), orthopyroxene (CaMgSi₂O₆+(Fe,Al)), serpentine (Mg₃Si₂O₅(OH)₄), and wollastonite (CaSiO₃).

54. The cement of claim 53, wherein the reactive solid comprises wollastonite (CaSiO₃).

55. The cement of claim 40, wherein the reactive solid comprises nanoparticles.

56. The cement of claim 55, wherein the nanoparticles are designed to target leaking fractures in shale.

57. The cement of claim 40, wherein the cement reduces the porosity and permeability of a mineral formation.
